(19) United States
(12) Patent Application Publication
(10) Pub. No.: US 2002/0080118 A1
(43) Pub. Date: Jun. 27, 2002

(54) Manually-operable input device

(75) Inventor: Graham G. Thomason, Red Hill (GB)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/015,830

(22) Filed: Nov. 30, 2001

(30) Foreign Application Priority Data
Dec. 27, 2000 (GB) 0031612.5

(51) Int. Cl. G09G 5/08

(52) U.S. Cl. 345/163

(57) ABSTRACT

A mouse (10) or other input device has a housing (12) to be held by the hand of the user, the outer contour of the housing being shaped to provide a natural way of holding the device. One or more touch sensitive inputs (18, 20) are provided, the or each input being located adjacent the natural resting position of a user's finger tip when holding the device in the natural way. This provides touch-sensitive controls adjacent the natural position of the fingers, so that sideways sliding of the fingers can be used to generate a control signal. This is found to reduce strain-related injury.

This invention relates to input devices for inputting information into computer systems. In particular, it relates to an input device for moving a pointer around the screen of a computer system and for inputting selection commands. A mouse is one example of such a device.

A conventional mouse comprises a housing to be held by the hand of the user. The underside of the housing is provided with a movement detector providing an output for controlling movement of a pointer on the screen. The outer surface of the housing is provided with one or more depressible buttons to enable a selection command to be generated. The computer system then interprets the selection command based on the current position of the pointer.

The sensitivity of the movement detector can normally be adjusted, and the mouse can therefore be configured to require very little movement to enable the pointer to move all round the screen of the computer system. Whereas movement of the pointer can in this way be relatively effortless, it has been found that the operation of the depressible buttons on the mouse can contribute to repetitive strain injury. This results particularly from the up and down movement of the fingers in order to operate the depressible buttons.

According to the invention, there is provided a manually-operable input device comprising a housing to be held by the hand of the user, the outer contour of the housing being shaped to provide a natural way of holding the device, wherein one or more touch sensitive inputs are provided on the device, the or each input being located adjacent the natural resting position of a user's finger tip when holding the device in the natural way, especially (but not exclusively) in the manner dictated by the shaping of the housing.

The device of the invention provides touch-sensitive controls adjacent the natural position of the fingers, so that sideways sliding of the fingers can be used to generate a control signal. This is found to reduce strain-related injury.

Preferably, the device further comprises a movement detector providing an output for controlling movement of a pointer.

Preferably, the or each input is flush with the surface of the housing. The touch sensitive input may comprise a light sensor, a pressure sensor or an impedance sensor.

The touch sensitive inputs may comprise first and second areas, so that each input can provide different control signals, for example equivalent to a single or double click of a conventional button.

The device may also have conventional depressible buttons. For example, each touch sensitive input may be provided on the surface of a depressible button, so that the user has the option of how to provide control signals.

The device of the invention preferably comprises a mouse, and may comprise a wireless mouse.

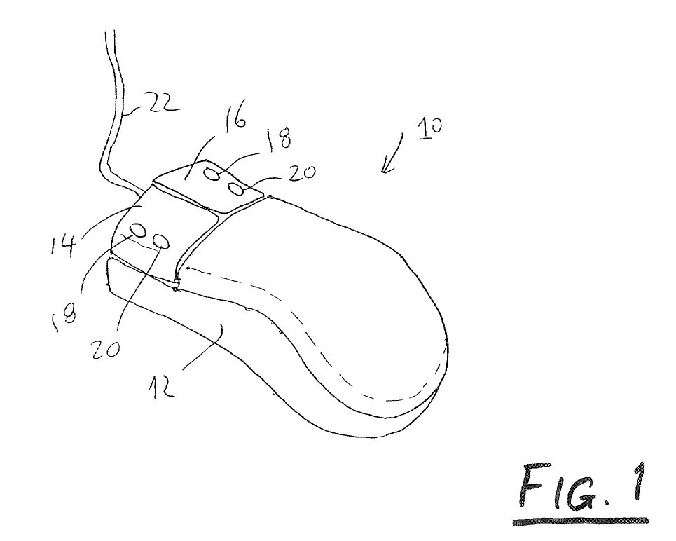

The invention will now be described, by way of example only, and with reference to the accompanying Figure (FIG. 1) which shows the device of the invention implemented as a mouse.

The Figure shows a mouse 10 comprising a housing 12 to be held by the hand of the user. The underside of the mouse 10 is provided with a conventional ball mechanism (not shown) which enables movement of the mouse across a surface to be detected. This provides an output signal which, in use of the mouse as an input device to a computer system, controls a pointer on the screen of the computer system, in conventional manner.

The shape of the housing 12 is designed and formed so that the users index finger rests naturally on a first button 14 and the middle finger rests naturally on a second button 16. Each button is provided with two touch-sensitive inputs 18, 20. Each pair of inputs 18, 20 may be considered as a single input device, as it is associated with a single finger of the user.

The touch-sensitive inputs 18, 20 are flush with the surface of the buttons 14, 16, and may therefore be considered to be flush with the surface of the housing 12 (considering the buttons to be part of the housing). The inputs 18, 20 are positioned to one side of the natural resting position of the finger tip when holding the mouse.

Various designs of touch-sensitive input device will be known to those skilled in the art. For example, a photodiode light sensor may be provided beneath a transparent window, and when light is blocked from the photodiode, this is detected as actuation of the respective input. Alternatively, each input device may comprise a capacitive sensor which detects a change in capacitance which results from the user's finger effectively defining one plate of a capacitor when touching the input device. As further alternatives, the touch-sensitive inputs may comprise pressure sensors, or impedance detectors.

In the example shown in the Figure, each input device comprises two touch-sensitive areas 18, 20. Touching one of these inputs 20 may be interpreted as corresponding to a single click of a conventional mouse button, whereas covering the other area 18 may be interpreted as corresponding to a double click of a conventional mouse button. Alternatively, both areas 18, 20 may need to be covered to produce a double-click control signal.

The single click output comprises a single output pulse, whereas the double click output comprises two pulses in rapid succession.

In the example shown in the Figure, the touch-sensitive inputs 18, 20 are provided on the surface of depressible buttons 14, 16. This enables the user to choose whether to use the touch-sensitive inputs or to use the conventional functionality of the buttons. Of course, the mouse may be designed solely with touch-sensitive inputs.

The mouse may be connected to the computer system by a wired link 22, or alternatively, a wireless link may be provided.

Although the invention has been described implemented as a mouse, the invention may also be applied to other manually operable input devices, and applied generally to devices designed to be held in a particular way. For example, the invention may be applied to a television remote control, or to a tracker ball. In the latter case, the device will be designed to locate fingers not used in moving the tracker ball in specific locations, and the touch-sensitive inputs will be adjacent those locations.

Various modifications will be apparent to those skilled in the art. The electronic hardware required to convert the input signals and the movement signals into appropriate format for recognition by a computer system is totally conventional and will be well known to those skilled in the art.

1. A manually-operable input device comprising a housing to be held by the hand of the user, the outer contour of the housing being shaped to provide a natural way of holding the device, wherein one or more touch sensitive inputs are provided on the device, the or each input being located adjacent the natural resting position of a user's finger tip when holding the device in the natural way.

2. A device as claimed in claim 1, wherein the device comprises a movement detector providing an output for controlling movement of a pointer.

3. A device as claimed in claim 1, wherein the or each input is flush with the surface of the housing.

4. A device as claimed in claim 1, wherein the or each touch sensitive input comprises a light sensor for detecting when the light is shielded from reaching the input.

5. A device as claimed in claim 1, wherein the or each touch sensitive input comprises a capacitive sensor, a pressure sensor or an impedance detector.

6. A device as claimed in claim 1, comprising a mouse.

7. A device as claimed in claim 1, wherein the or each touch sensitive input comprises first and second detectors, wherein touching one detector provides a first output and touching both detectors provides a second output.

8. A device as claimed in claim 7, wherein the first output comprises a single output pulse, and the second output comprises two output pulses in rapid succession.

9. A device as claimed in any one of claims 1 to 6, wherein the or each touch sensitive input comprises first and second detectors, wherein touching one detector provides a first output and touching the second detector provides a second output.

10. A device as claimed in claim 9, wherein the first output comprises a single output pulse, and the second output comprises two output pulses in rapid succession.

11. A device as claimed in claim 1, wherein each touch sensitive input is provided on the surface of a depressible button.

12. A device as claimed in claim 2, wherein the movement detector output and the output of the or each touch sensitive input is output from the device by a wireless link.
